(19) United States
(12) Patent Application Publication
(10) Pub. No.: US 2005/0114364 A1
(43) Pub. Date: May 26, 2005

(54) Methods and apparatuses for processing genealogical data

(76) Inventors: Daniel K. Tebbs, Kirkland, WA (US); Craig L. Turner, Bothell, WA (US); David H. Tryon, Redmond, WA (US)

Correspondence Address: Mark S. Peloquin;PELOQUIN, PLLC, Suite 4100, 800 Fifth Avenue, Seattle, WA, 98104-3100, US

(21) Appl. No.: 10/723,724

(22) Filed: Nov. 26, 2003

(51) Int. Cl. G06F 17/00

(52) U.S. Cl. 707/100

(57) ABSTRACT

A method includes receiving a genealogical data element and determining a rating, wherein the rating is associated with the genealogical data element. The method also includes receiving a rating associated with a second genealogical data element; and using the rating associated with the second genealogical data element to adjust the rating associated with the genealogical data element. An apparatus includes a genealogical data element and a rating, wherein the rating is associated with the genealogical data element and the rating is determined from a rating of a first genealogical data element and a rating of a second genealogical data element.

### BACKGROUND OF THE INVENTION

1. Field of Invention

The invention relates generally to genealogical research, and more specifically to apparatuses and methods used to process genealogical data.

2. Art Background

Genealogy is the study of the descent of a person from ancestor to ancestor throughout time past. Necessarily, genealogy requires a researcher to study historical records and then to deduce or evidence the descent or existence of a person from existing information. The quality of the existing information is variable; for example, the location and accuracy of the information can range from a high quality source such as a birth certificate to a low quality source such as an oral account four generations old. As the researcher gathers information from various sources, the compilation of information, a genealogical record, will often times contain information that is of high quality and information that is of low quality. A given researcher's genealogical record will normally have data of variable quality included therein.

Compounding the problem of quality, genealogical research is pursued by people with different research backgrounds, resulting in different levels of competency with research techniques. Different backgrounds and research techniques lead to variations in the quality of the genealogical record since one researcher can be prone to include data from less reliable low quality sources and another researcher can be prone to include data from high quality sources. When multiple researchers post data to a common data base, inconsistencies in the respective research practices of the researchers can lead to degradation in the quality of the data and the resulting credibility of the data base. For example, a high quality entry can be disputed and replaced by a low quality entry, thereby unintentionally corrupting the data base since there is presently no way to measure the quality of the genealogical data.

Other problems exist within the current structure used to assemble and record genealogical data. Since genealogy is directed to the study of history, it is often the case that a researcher does not have enough data on an ancestor to completely identify the ancestor and place the ancestor within a “family tree.” The existing format used for data flowing from genealogical research is focused on an ancestor's given name, family name, birth information, such as birth date and place as well as other intermediate information; marriage, offspring, and death. The current format used for genealogical data does not enable the researcher to respond to the challenges presented by the uncertainty attendant upon the nature of genealogical research.

What is needed is a way to uncover and quantify the ambiguity presented within the body of existing or future genealogical data. Additionally, techniques are needed to improve future genealogical research so that the overall quality of data flowing from the genealogical community is improved.

### BRIEF DESCRIPTION OF THE DRAWINGS

The invention may best be understood by referring to the following description and accompanying drawings that are used to illustrate embodiments of the invention. The invention is illustrated by way of example in the embodiments and is not limited in the figures of the accompanying drawings, in which like references indicate similar elements.

FIG. 1 illustrates a general family tree.

FIG. 2A illustrates a representation of an individual and attributes of the individual according to one embodiment of the invention.

FIG. 2B shows a representation of the individual according to one embodiment of the invention.

FIG. 3A illustrates a process to rate genealogical data elements according to one embodiment of the invention.

FIG. 3B depicts a process to rate a genealogical data element utilizing multiple genealogical data elements according to one embodiment of the invention.

FIG. 3C illustrates a process to form a genealogical data element from ratings of genealogical data elements according to one embodiment of the invention.

FIG. 3D depicts a process to adjust the rating of a genealogical data element according to one embodiment of the invention.

FIG. 4 shows one embodiment of a rating tree.

FIG. 5 illustrates a component of a rating criterion for source-information according to one embodiment of the invention.

FIG. 6 illustrates an additional component of the rating criterion for source-information according to one embodiment of the invention.

FIG. 7A depicts additional components of the rating system for genealogical data elements representing source-information according to one embodiment of the invention.

FIG. 7B illustrates an alternative set of components of the rating system for genealogical data elements representing source-information according to one embodiment of the invention.

FIG. 8 shows one embodiment of a criterion for rating genealogical data associated with event/link details

FIG. 9 illustrates one embodiment of criteria for rating genealogical data associated with attribute details of an individual.

FIG. 10 shows a rating criterion for an event sequence and a rating criterion for an individual according to one embodiment of the invention.

### DETAILED DESCRIPTION

In the following detailed description of embodiments of the invention, reference is made to the accompanying drawings in which like references indicate similar elements, and in which is shown by way of illustration, specific embodiments in which the invention may be practiced. These embodiments are described in sufficient detail to enable those of skill in the art to practice the invention. In other instances, well-known circuits, structures, and techniques have not been shown in detail in order not to obscure the understanding of this description. The following detailed description is, therefore, not to be taken in a limiting sense, and the scope of the invention is defined only by the appended claims.

Apparatuses and methods are described to quantify the quality of genealogical data. Such quantification is expressed in a rating applied to the genealogical data. A research format centered on the concept of an “individual” is described, with which genealogical data is organized, stored, and shared with other researchers.

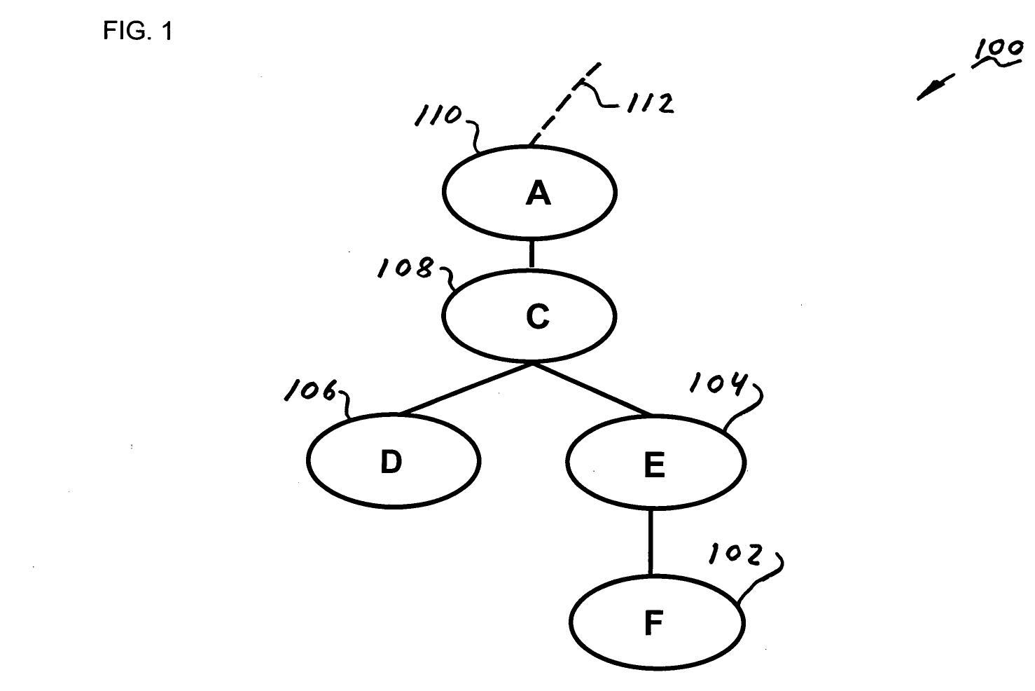

FIG. 1 illustrates a general family tree. With reference to FIG. 1, a family tree is shown generally at 100 accounting for four generations, wherein each generation is indicated by row. The parent of person 102 is indicated by ancestor 104. A grandparent of 102 is indicated by 108 and a great grandparent is indicated by 110. An uncle or aunt can be indicated by 106 and other relatives of attenuated relation are indicated by 112. The existence of a person 102 presupposes the fact that the person has descended from a succession of ancestors generally shown within FIG. 1. Research on the ancestors requires research into the historical record.

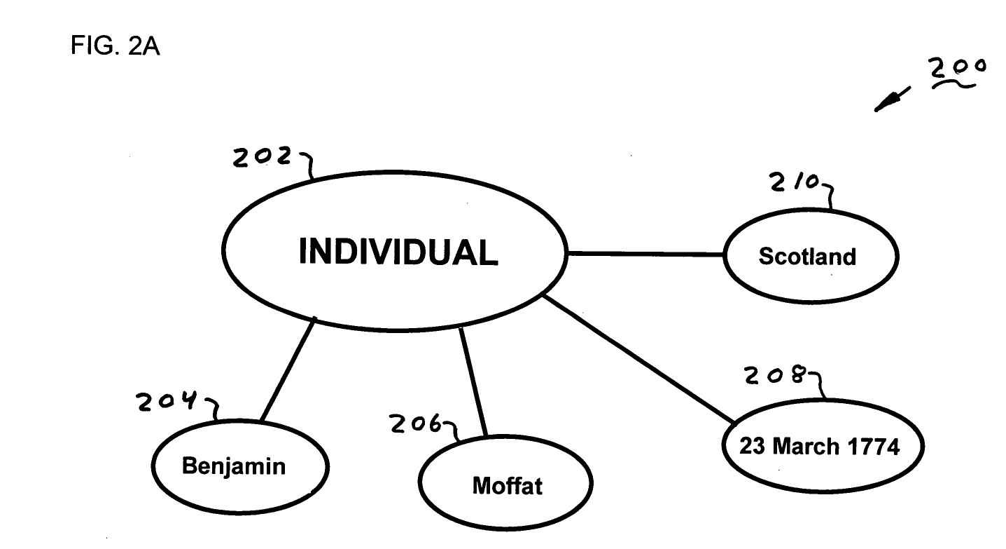

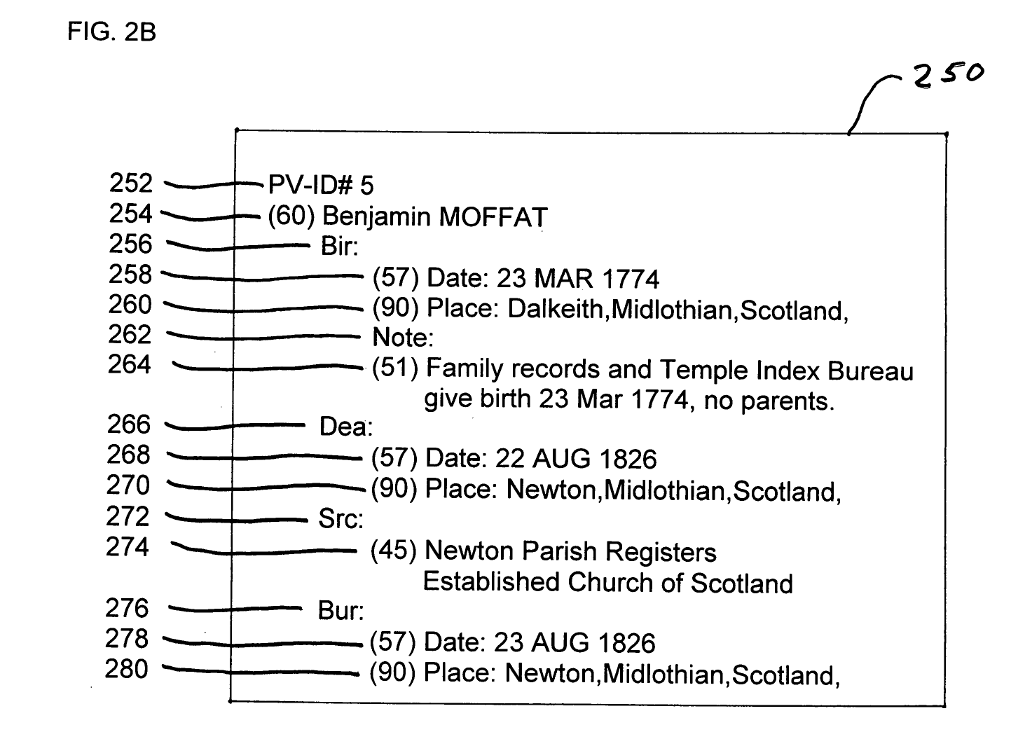

FIG. 2A illustrates a representation of an individual and attributes of the individual according to one embodiment of the invention, shown generally at 200. With reference to FIG. 2A, an individual is indicated at 202. In the context of this description, the term “individual” is used to indicate our current representation with respect to the existence of an individual. Similarly, attributes are pieces of information associated with an individual. The information associated with an individual, that is the subject of attributes, is to be construed broadly within this description to include any and all information that pertains to the individual. Such examples include, but are not limited to, birth, marriage, offspring, death, jobs held, schools attended, relationships, events, etc. Within the example of FIG. 2A, the individual 202 has a first name (an attribute) of “Benjamin” indicated at 204 and a last name (another attribute) of “Moffat” indicated at 206. Benjamin Moffat has a birth date (another attribute) of 23 Mar. 1774 indicated at 208. Benjamin Moffat was born in Scotland (another attribute), indicated by 210.

With reference back to FIG. 1, each ancestor in the family tree can be represented as an individual with attributes similar to the attributes shown in FIG. 2A. The genealogical researcher has a concept or a claim to support the existence of an individual, but cannot always be sure that a particular piece of genealogical data is associated with an individual. Therefore, in the context of genealogical research, “claims” to an individual and “claims” to attributes of the individual are associated with each of the ancestors shown in FIG. 1.

Within the context of genealogical research, as presented in this description, all of the aforementioned claims to attributes (and the broad meaning attached thereto) are referred to as genealogical data elements. Additionally, within one or more embodiments, ratings of genealogical data elements are referred to as genealogical data elements and are processed accordingly. Therefore, the group of genealogical data elements includes, but is not limited to, individuals, families, ratings, adjusted ratings, various events, some events give rise to relationships that result in offspring that provide a link from one individual to another and from one family to another. Included in the events attendant upon an individual are the commencement of life; such events include birth, time and place. Events also include the events that result in the culmination of life, e.g., death and the associated time, and place. Additionally, events can include all of the other occurrences that can happen to a person during the period of life that could generate data that would then be researched by genealogical researchers. Some examples of these events are, but are not limited to, events of a religious nature such as a christening, a communion, a confirmation, church membership, etc. Other examples of events combine both a religious and a state interest, such as but not limited to, betrothal, engagement, marriage, and divorce. Other events can include ownership of property, holding of a job(s) or office(s), membership in organizations and professional communities, addresses, a duration of residence at a particular address, photos, multimedia, sound files, fingerprint records, retina scans, dental records, medical records, or any form of identification.

FIG. 2B shows an association of genealogical data elements according to one embodiment of the invention. With reference to FIG. 2B, a genealogical data record is shown generally at 250. In this embodiment, the record 250 organizes and displays the claims to the individual evident within the genealogical data elements shown in FIG. 2A. Individual 202 (FIG. 2A) is indicated at the top of the record 250 at 252. An attribute heading corresponding to the first name “Benjamin” (204 in FIG. 2A) and the last name “Moffat” (206 in FIG. 2A) is listed within 254. Entries for the attribute corresponding to “Birth” are listed under heading 256 “23 Mar. 1774” (208 in FIG. 2A). Entries for the attribute corresponding to “Death” are listed under heading 266. Entries for the attribute corresponding to “Source” are listed under heading 272. Entries for the attribute corresponding to “Burial” are listed under heading 276. Many other formats for the display or storage of the genealogical data elements are possible as will be observed by those of ordinary skill in the art. The present invention is not limited to the format shown within FIG. 2B. For example, in other formats indicia to indicate a family can be included. Ratings indicated by the quantities within parentheses, such as (60) at 254, will be described in conjunction with the figures that follow.

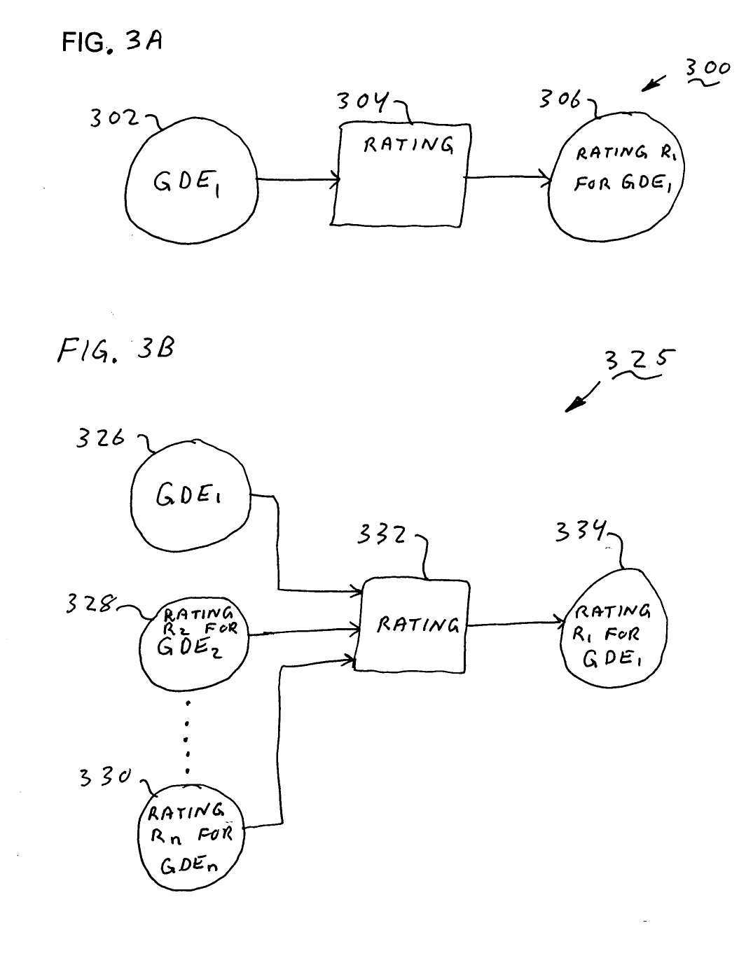

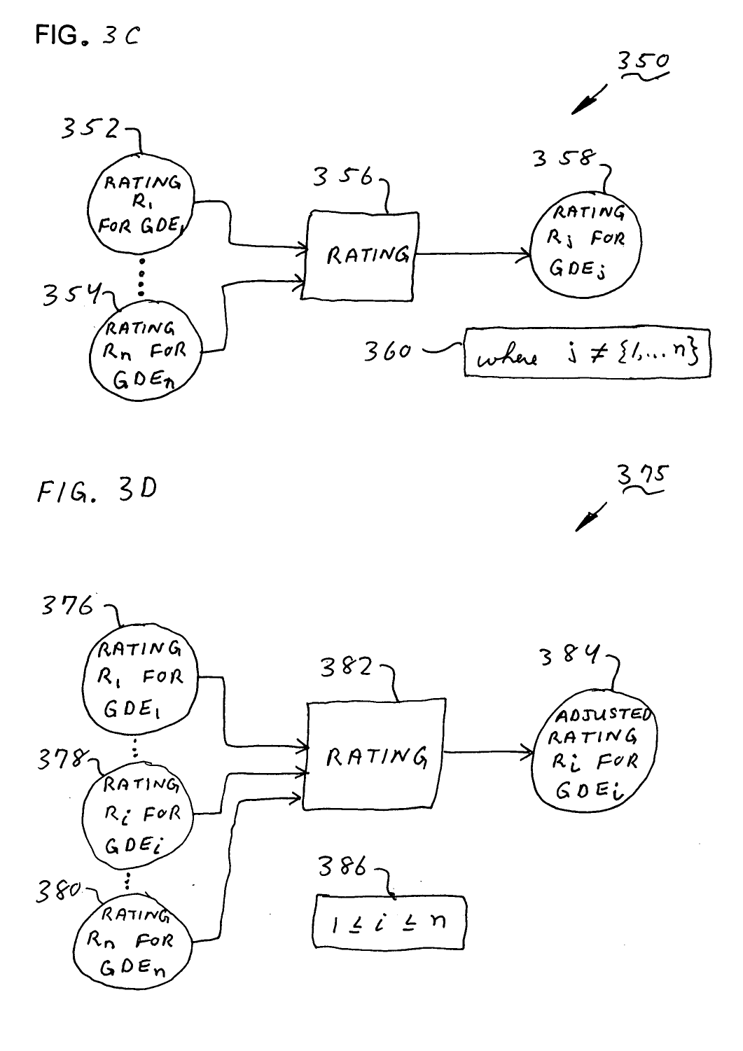

FIG. 3A illustrates a process to rate genealogical data elements according to one embodiment of the invention. With reference to FIG. 3A, a system for rating genealogical data elements is shown generally at 300. The process begins when a genealogical data element 302 is obtained from a source of genealogical data. Such a source can be an existing genealogical data base such as any standard GEDCOM data file, the output of Family Tree Maker™ or Ancestral Quest™, the Ancestral File or Ancestry databases, etc. Such a source could also be the recent results of research conducted by both lay and professional genealogy researchers. Additionally, different sources exist, created over time, that use a variety of different file formats for data storage. One example of a file format is the GEDCOM 5.5 file format. The present invention is not limited by the file format used to obtain the genealogical data element 302.

Block 304 applies at least one rating criterion to the genealogical data element to obtain a rating for the genealogical data element. The rating criterion can be different for different genealogical data elements, while some rating criterion can be the same for the different genealogical data elements. For example, as previously described, genealogical data elements are associated with a plethora of different information. Some of the genealogical data associated with particular information might be found in a different location than genealogical data associated with other information. An example of the foregoing is that some genealogical data is of state origin and is archived differently than genealogical data that is of private origin. Rating criterion can, therefore, differ for varying types of genealogical data elements.

Block 306 associates the rating with the genealogical data element. An example of a rating associated with a genealogical data element is the number fifty seven in parenthesis (57) in FIG. 2B at 258.

In one or more embodiments, a debit or a credit will be transferred in exchange for determining a rating of a genealogical data element(s). In one or more embodiments, a debit or a credit will be transferred in exchange for maintaining a data base of genealogical data elements and their associated ratings. An example of a debit is an invoice or a bill to show what is owed and an example of a credit is payment in the form of valuable consideration.

FIG. 3B depicts a process to rate a genealogical data element utilizing multiple genealogical data elements according to one embodiment of the invention. With reference to FIG. 3B, a process to rate a genealogical data element utilizing other genealogical data elements is shown generally at 325. A genealogical data element 326 is received from a source of genealogical data as described previously in conjunction with FIG. 3A and is input to a rating block 332. A rating associated with a second genealogical data element is received at 328 and is input to the rating block 332. Additionally, there may be additional ratings (a general number n) associated with other genealogical data elements (a corresponding general number n) as indicated at 330, which are received and input to the rating block 332. The rating(s) associated with 328 through 330 are used to determine the rating 334 associated with the genealogical data element 326. Such an association can be performed, for example, by loading appropriate data into registers of a data processing system. Determining a rating for a genealogical data element according to the process at 325 results in the rating 334 for genealogical data element 326 being influenced by the ratings for the other genealogical data elements.

FIG. 3C illustrates a process to form a genealogical data element from ratings of genealogical data elements according to one embodiment of the invention. With reference to FIG. 3C, the process is illustrated generally at 350. A general number of ratings for genealogical data elements indicated by n, (where n can also equal 1) is associated as shown at 352 to 354. Rating block 356 receives the ratings 352 through 354 and applies one or more rating criterion to the ratings to determine a rating for a genealogical data element at 358. Such a genealogical data element, 358, draws its rating from the ratings of the inputs to rating block 356. In this embodiment, the genealogical data element 358 is a rating. An example of a genealogical data element 358 is the “concept” of an individual expressed as a rating, such as 358. Since genealogical data element 358 is determined from rating inputs, it is referred to as being non-identical with the inputs, hence, the designation expressed by the relation at 360.

FIG. 3D depicts a process to adjust the rating of a genealogical data element according to one embodiment of the invention. With reference to FIG. 3D, a general number (n) of ratings for the corresponding genealogical data elements are associated as indicated by 376, and 378 through 380. The ratings 376, and 378 through 380 are input to a rating block 382 where one or more rating criterion are applied to the ratings to determine an adjusted rating. In the embodiment shown, an adjusted rating for the i^{th} genealogical data element, where i is an element of the group 1 through n (as indicated at 386) is adjusted in the block 382. The i^{th} rating was selected for the purpose of illustration only, it will be observed that the i^{th} rating is arbitrary and can represent any of the ratings discussed within this description.

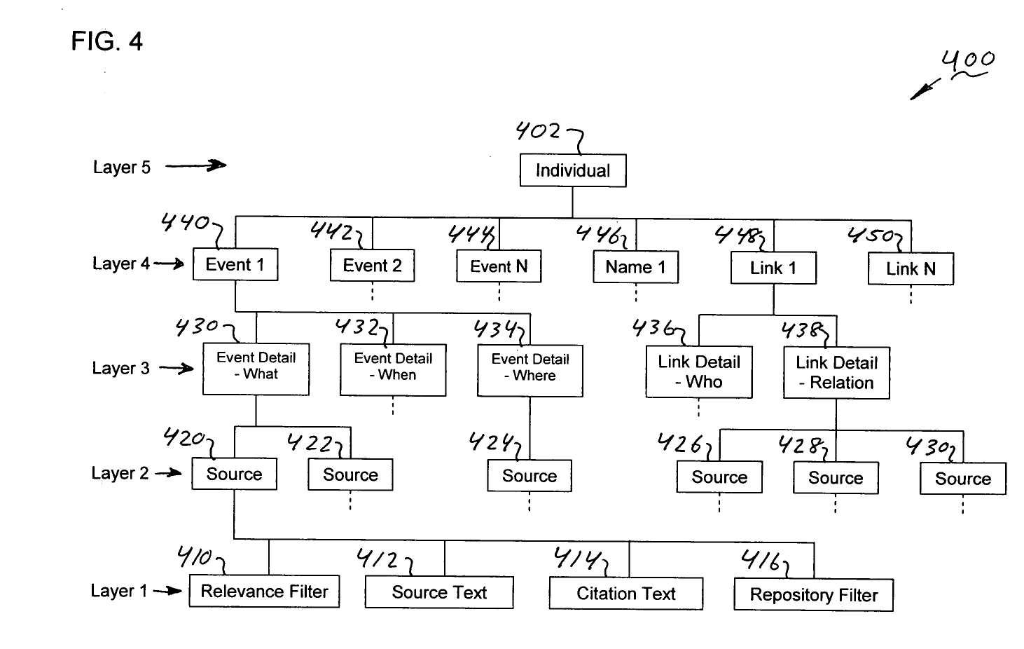

According to various embodiments of the invention, rating genealogical data can be done at the genealogical data element level or the rating can be performed in a layered method, where the rating of one layer is used during the rating of the next layer until a rating for an individual or some other genealogically related item is accomplished. Such a successive approach to building a rating for an individual based on a multi-layer rating methodology is described in FIG. 4.

FIG. 4 shows one embodiment of a multi-layered rating methodology depicted as a rating tree. With reference to FIG. 4, a rating tree is shown generally at 400. According to the embodiment shown at 400 the rating tree has five layers. Other implementations of a rating tree can have either more or less than five layers. The number of layers used for the tree is general and does not limit the present invention. For example, the description provided for FIG. 3A can be viewed as a single layer of rating, wherein a single genealogical data element is rated thereby. Additionally, the processes described within FIG. 3A, FIG. 3B, FIG. 3C, and FIG. 3D can be applied singly within one layer or the processes can be applied multiple times within a layer. Those of skill in the art will recognize many variations in the application of the processes taught in the figures, all of which are within the intended scope of embodiments of the present invention. With reference back to FIG. 4, the first layer is generally termed a source-information layer and the second layer is generally termed a source layer. The third layer is generally termed an event detail layer, the fourth layer is generally termed an event layer; however, within this embodiment, events, names, and links are rated therein, and the fifth layer identifies the individual. Within the embodiment shown in FIG. 4 ratings are applied to each layer and the ratings for each layer flow up to and influence the rating assigned to the individual at 402.

According to the embodiment shown in FIG. 4, the source-information layer includes four components; a relevance filter 410, a source text filter 412, a citation filter 414, and a repository filter 416. Each component is evaluated using a rating criterion that produces a rating for each of the respective components. The components are then mathematically combined to produce a source rating, for example a rating for source 420 is comprised of ratings for component 410, 412, 414, and 416. Each of the other sources 422, 424, 426, 428, and 430 can be evaluated in a similar fashion; obtaining source ratings thereby. More than one source can report genealogical data on the same event detail, such as source 420 and source 422 reporting on event detail 430. Evaluation of the individual source ratings 420 and 422 can improve the quality of the genealogical data by allowing comparison of the genealogical data after being rated by a rating schema as described herein.

According to one embodiment of the invention, layer three is used to divide genealogical data into events (layer 4) and event details (layer 3) which corresponds to a division of attributes and attribute details with respect to an individual. Such division and labeling of the body of genealogical data is arbitrary. Other divisions and labels can be used to describe the genealogical data resulting in other rating schema. The present invention is not limited to one particular rating schema, but anticipates other divisions of data, such as those previously described in conjunction with FIG. 3A, FIG. 3B, FIG. 3C, and FIG. 3D. Any number of event details can be accommodated within layer 3 as indicated by 430, 432, 434, 436, and 438. Relationships are indicated by links and are indicated within layer 3 as link details 436, and 438. Any number of links can be expressed within the tree structure shown in FIG. 4. As can be observed from the tree 400, the ratings within layer 4 flow up to and influence the rating of the individual at 402. The rating for the individual is an indication of the certainty of the claim for the previous existence of the individual in light of the genealogical data element(s).

Returning to layer 1, genealogical data element rating criteria are used in determining ratings for each of the source-information components 410, 412, 414, and 416.

Generally, ratings will be obtained by applying a rating criterion (an equation or algorithm) to the genealogical data element(s). Any scale can be used to convey a change in magnitude of the rating of one genealogical data element with respect to another. For example, a numerical scale ranging from 1 to 10 could be employed; alternatively, scales from 1 to 1000 or 1 to 10,000 could be employed. Yet other scales based on letters of an alphabet or colors could be employed for the rating. The present invention is not limited by the particular way in which the rating is quantified and presented. For convenience, and due to an acceptable range covered thereby, the scale of 1 to 100 will be used, expressed as a percentage. Thus, ratings of minimum value will be assigned the value 0% and ratings of maximum value will be assigned the rating 100%. It will be known to those of ordinary skill in the art that such an assignment is arbitrary and that other scales could be used.

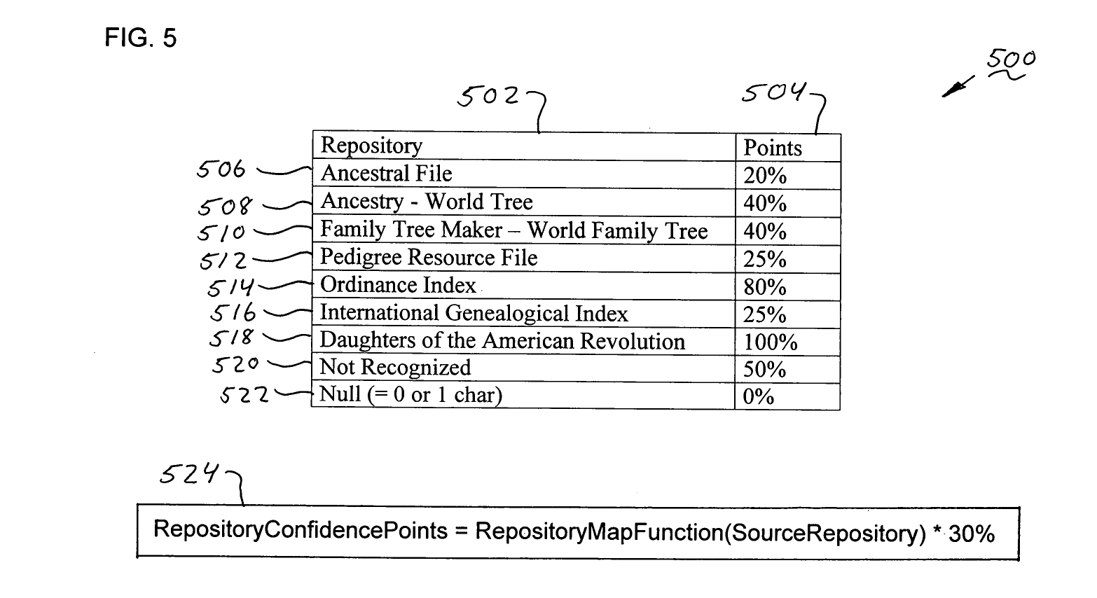

FIG. 5 illustrates a component of a rating criterion for rating source-information according to one embodiment of the invention. With reference to FIG. 5, a rating criterion for the repository filter 416 (FIG. 4) is shown generally at 500 in FIG. 5. With respect to genealogical data, the type of repository has a certain “confidence” associated with it, which influences the quality of the genealogical data and influences the composite rating on the source. Accordingly, more points are assigned based on the type of repository. Each row within column 502 lists a type of repository and within column 504; the number of points assigned to the various types of repositories is listed. Within equation 524, “RepositoryMapFunction(SourceRepository)” returns the appropriate number of points that correspond to the type of repository wherein the particular genealogical data was obtained. The returned value is multiplied by a percentage and is assigned to “RepositoryConfidencePoints” which provides a rating on the type of repository. This rating value is associated with 416 (FIG. 4), in one embodiment.

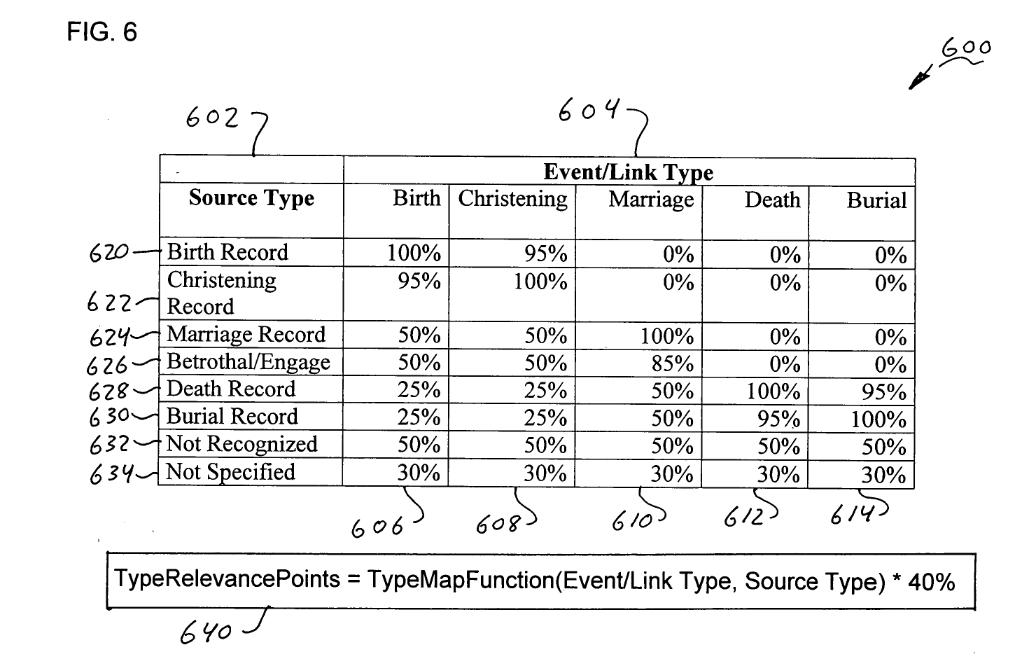

FIG. 6 illustrates an additional component of a rating criterion for source-information according to one embodiment of the invention. With reference to FIG. 6, a rating criterion for the RelevanceFilter 410 (FIG. 4) is shown generally at 600 as a table. Source Type is indicated at column 602 and has values as shown within column 602 at each row. For example, Birth Record is indicated at 620, Christening Record is indicated at 622, Marriage Record is indicated at 624, Betrothal/Engagement is indicated at 626, Death Record is indicated at 628, Burial Record is indicated at 630, a record that is not recognized is indicated at 632, and a record not specified within column 602 is indicated at 630. An Event/Link Type 604 includes columns for Birth at 606, Christening at 608, Marriage at 610, Death at 612, and Burial at 614. The lookup table can be implemented as a user defined function (TypeMapFunction) that returns the appropriate value from table 600 based on the input to TypeMapFunction. For example, an Event/Link Type equal to Birth and a Source Type of Birth Record will return a value of 100% since the event is highly correlated with the source type. In another example, an Event/Link Type equal to Burial and a Source Type of Birth Record will return a value of 0% since the event is highly uncorrelated with the source type. Other combinations of input into the function will produce various results depending on the level of correlation between the Event Type or Link Type and Source Type.

A rating criterion applied to the relevance of the source-information represented by the output of the TypeMapFunction is illustrated at 640 where the output of the TypeMapFunction is multiplied by a percentage. The resulting value, associated with a variable TypeRelevancePoints, is the rating for the genealogical data element associated with Relevance Filter 410 (FIG. 4), in one embodiment.

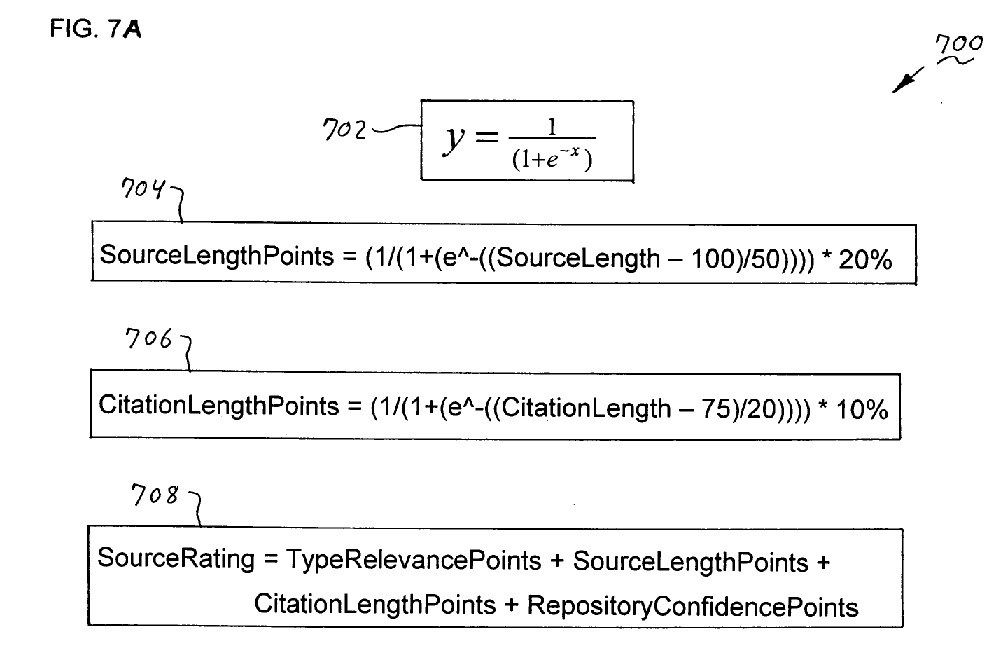

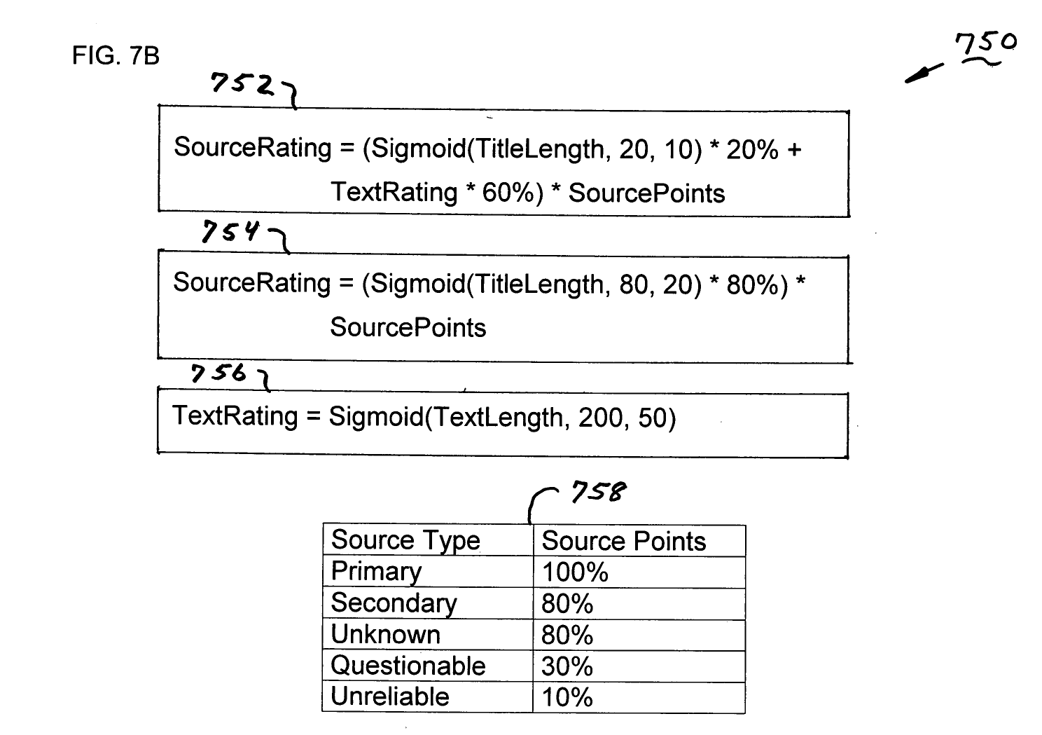

FIG. 7A depicts additional components of the rating system for genealogical data elements representing source-information according to one embodiment of the invention. With reference to FIG. 7A, additional components of the rating system are shown generally at 700. A transfer function, such as the sigmoid function, is shown at 702 and is implemented in one embodiment of the invention as part of the rating criterion for the source-information, length of source, and length of citation. Other transfer functions besides the sigmoid function can be used to determine numerical rating for genealogical data elements. User defined functions can be implemented to obtain ratings of genealogical data elements. A length of the text used to identify the source of a genealogical data element is indicated by a variable SourceLength. The rating criterion indicated at 704 is applied to SourceLength returning a numerical value after application of the sigmoid function and multiplication by 20%. The final result of applying the rating criterion 704 is to obtain a value for the variable SourceLengthPoints, which is a rating for the genealogical data element that is associated with 412 in FIG. 4, in one embodiment.

A genealogical data element that represents a length of a citation for a source-information is represented by CitationLength. A rating criterion as shown at 706 is applied to the value of CitationLength to determine a rating indicated by CitationLengthPoints. The value of CitationLengthPoints is a rating for the genealogical data element that is associated with 414 (FIG. 4), in one embodiment.

The ratings indicated at 410, 412, 414, and 416 are used at 708, by application of a rating criterion therein to obtain a rating for the source, which is then associated with the variable SourceRating. This rating is associated with 420 in FIG. 4, in one embodiment.

Various processes can be applied to genealogical data elements within the scope of the teachings presented in this description. Many alternative ways exist to obtain a rating for the same genealogical data element. For example, the foregoing description directed to processing genealogical data elements of source-information in order to obtain a rating for a source, such as 420 in FIG. 4, can be modified. One such modification is shown in FIG. 7B. FIG. 7B illustrates an alternative set of components of the rating system for genealogical data elements representing source-information according to one embodiment of the invention. With reference to FIG. 7B, another process of obtaining a rating for a source “SourceRating” is shown generally at 750. In one embodiment, a rating criterion for determining a rating for a source is illustrated at 752 when the text associated with a genealogical data element is available. Alternatively, 754 is used to determine the rating if the text is unavailable. A text rating is determined using 756, based on the length of the text, and is associated with a variable TextRating, the result is input into 752. An additional input into 752 is a value for the variable SourcePoints. Table 758 provides a number of points associated with a given type of source. An example of a primary source is an eyewitness to an event, such as a nurse recording information on a patient. A primary source returns a value of 100% for the variable SourcePoints. A copy of a primary source is an example of a secondary source and would return a value of 80% for SourcePoints. An unknown source, an example being an unknown author, will return a value for SourcePoints of 80%. A questionable source will return a value for SourcePoints of 30%. An unreliable source, an example being a census taker who fabricates numbers, returns a value of 30% for SourcePoints. For a given genealogical data element, table 758 returns the appropriate value for SourcePoints, which is used within 752 to determine a rating that is associated with the variable SourceRating. Alternatively, if a genealogical data element does not have available text, 754 is used to determine a rating that is associated with the variable SourceRating. In one embodiment, the value for SourceRating, 752, is a rating for the genealogical data element associated with 420 in FIG. 4. Other processes and rating criterion for determining ratings will be recognized by those of skill in the art, in light of the teachings presented in this description; accordingly, all such other processes are encompassed by and are within the scope of the teachings presented herein.

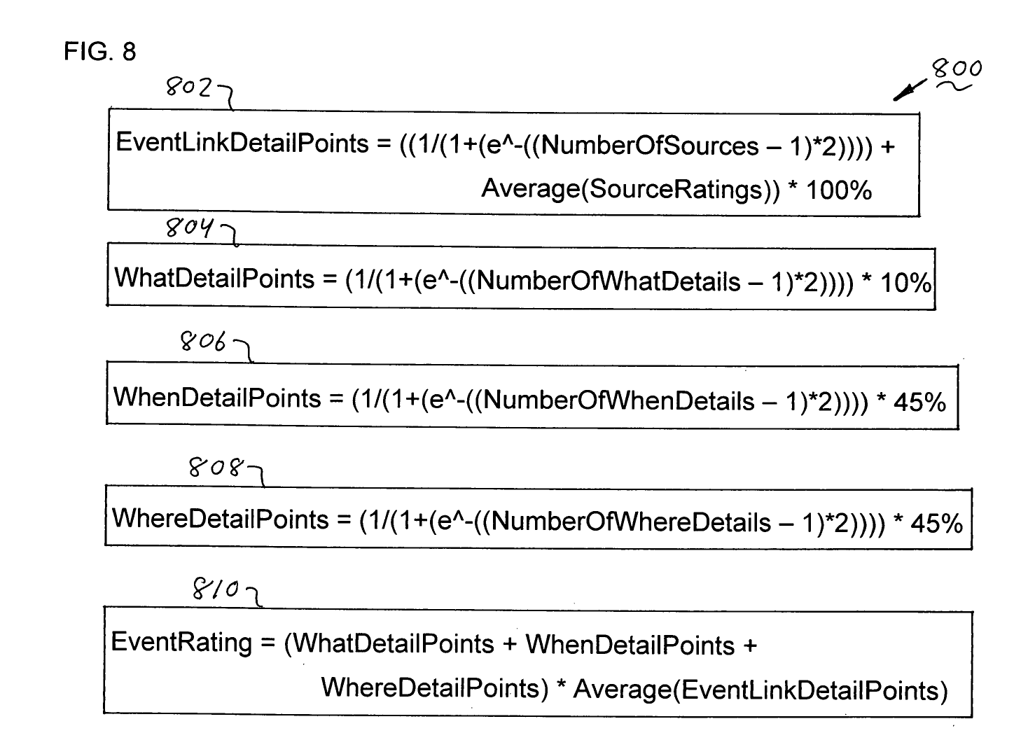

In layer 3, of the rating tree shown in FIG. 4, ratings for event details and link details are calculated according to one embodiment of the invention. FIG. 8 shows one embodiment of a criterion for rating genealogical data associated with event/link details. With reference to FIG. 8, a variable, NumberOfSources, is used to represent the number of source genealogical data elements attached to a genealogical data element that represents an event detail or a link detail. In one embodiment, NumberOfSources indicates the number of sources that have reported genealogical data elements on a particular event detail. The number of sources is input to a rating criterion at 802 along with the average of the source ratings, such as the source ratings determined by 708 or 752. A rating, EventLinkDetailPoints, is determined at 802 and is an input to rating criterion 810.

Ratings associated with the variables, WhatDetailPoints, WhenDetailPoints, and WhereDetailPoints, are determined by rating criterion 804, 806, and 808, respectively. Within the respective rating criterion, genealogical data elements pertaining to the number of details addressing what, when, and where are supplied to the appropriate function to obtain numerical results that become ratings for the variables WhatDetailPoints, WhenDetailPoints, and WhereDetailPoints. The ratings associated with WhatDetailPoints, WhenDetailPoints, and WhereDetailPoints are used together with the rating associated with EventDetailPoints to determine a rating for an event at 802. In one embodiment, the rating associated with WhatDetailPoints is the rating that is associated with 430 in FIG. 4. In one embodiment, the rating associated with WhenDetailPoints is the rating that is associated with 432 in FIG. 4. In one embodiment, the rating associated with WhereDetailPoints is the rating that is associated with 434 in FIG. 4. In one embodiment, the rating associated with EventRating is the rating that is associated with 440 in FIG. 4. In one embodiment, the process described to determine a rating for EventRating has also been illustrated in FIG. 3D.

In one or more embodiments, the ratings for 436 (FIG. 4) and 438 (FIG. 4) can be determined using the process illustrated within FIG. 8.

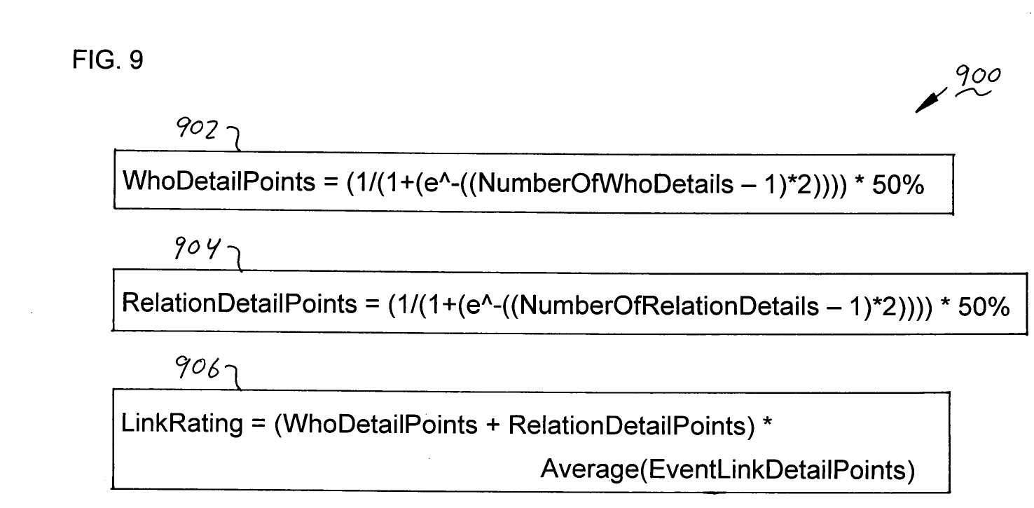

FIG. 9 illustrates, in one embodiment, criteria for rating genealogical data associated with an individual. With reference to FIG. 9, rating criteria are illustrated generally at 900. In one embodiment, the rating criteria embody the principles that higher rated events and links imply a more accurate and complete individual. The number of details pertaining to the identity of the individual is indicated by a variable NumberOfWhoDetails. Genealogical data element(s) corresponding to NumberOfWhoDetails are input to a function indicated in 902 to determine a rating that is associated with WhoDetailPoints. Genealogical data elements relevant to a number of details pertaining to relationships that are possibly associated with an individual are indicated by NumberOfRelationDetails. A rating criterion indicated at 904 is applied when a value for NumberOfRelationDetails is input and the function at 904 results in a rating being determined and associated with RelationDetailPoints. The ratings associated with WhoDetailPoints and RelationDetailPoints are used as inputs to a rating criterion shown at 902 to determine a rating that is associated with LinkRating at 906.

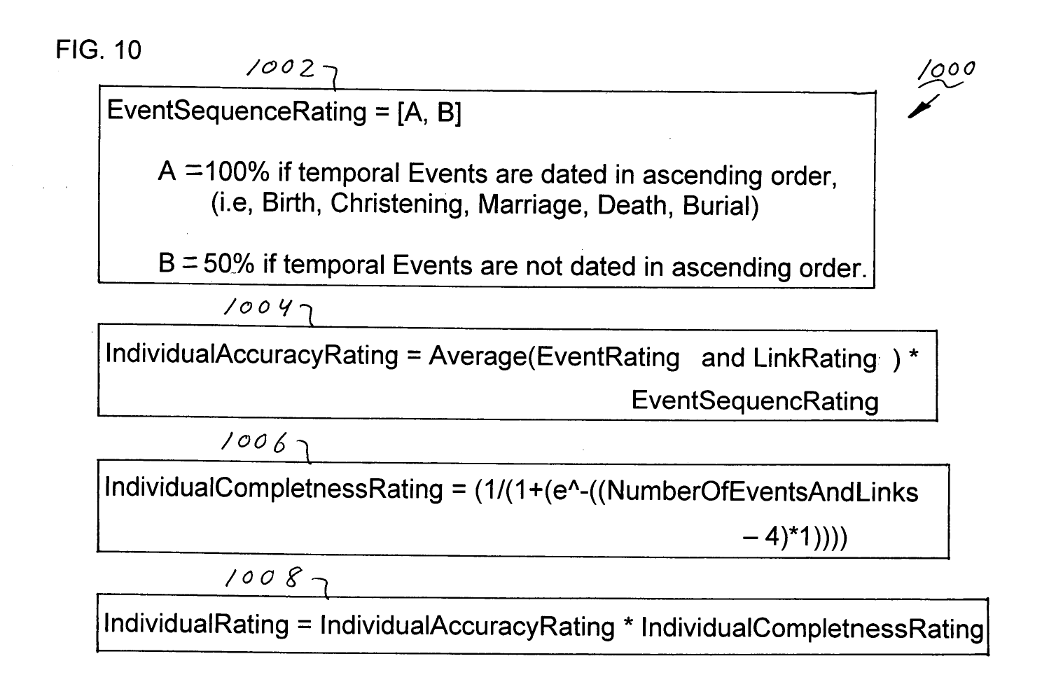

In one embodiment, the process to determine a rating for a claim to an individual proceeds by evaluating the sequence of events pertaining to the individual and determining a rating based on the sequence. FIG. 10 shows a rating criterion for an event sequence and a rating criterion for an individual according to one embodiment of the invention. With reference to FIG. 10, additional rating criteria for an individual are shown generally at 1000. A rating criterion to determine a rating based on a sequence of events is shown at 1002. EventSequenceRating takes on one of two values depending on the chronological order of the events thought to belong to an individual. If the events are in sequence (chronological order) a rating of 100% is returned and associated with EventSequenceRating. If the events are not in sequence (chronological order) a value of 50% is determined and associated with EventSequenceRating.

A rating indicating an “accuracy” of a claim to an individual is determined by rating criterion 1004 and a rating indicating the “completeness” of the claim to an individual is determined by rating criterion 1006. A rating to the overall claim to the individual is determined by rating criterion 1008 utilizing ratings associated with the variables IndividualAccuracyRating from 1004 and IndividualCompletenessRating from 1006. In one embodiment, the process described above with respect to FIG. 9 and FIG. 10, to determine a rating for the claim to an individual, has also been illustrated in FIG. 3D.

In one embodiment, ratings described herein can be applied to genealogical data elements to produce the ratings illustrated in FIG. 2B. With reference to FIG. 2B, a rating to the claim of an individual can be determined from appropriate genealogical data elements to be 60%. A reporting format for such a rating can be as shown in FIG. 2B at 254 by the indicia (60), where the parentheses around a number indicate percentage, thus (60) indicated 60%. A rating of genealogical data element(s) for a date associated with birth is determined to be (57) and is displayed at 258. A rating of genealogical data element(s) associated with a place of birth is determined to be (90) and is displayed at 260. A rating of genealogical data element(s) pertaining to a note associated with birth is determined to be (51) and is displayed at 264. A rating of genealogical data element(s) pertaining to a date of death is (57) and is displayed at 268. A rating of genealogical data element(s) pertaining to a place of death is determined to be (90) and is displayed at 270. A rating of genealogical data element(s) pertaining to a source of the genealogical information is determined to be (45) and is displayed at 274. A rating of genealogical data element(s) pertaining to a date of burial is determined to be (57) and is displayed at 278 and a rating of genealogical data element(s) pertaining to a place of burial is (90) and is displayed at 280.

In one or more embodiments, a debit or a credit will be transferred in exchange for determining a rating of a genealogical data element(s). In one or more embodiments, a debit or a credit will be transferred in exchange for maintaining a data base of genealogical data elements and their associated ratings. An example of a debit is an invoice or a bill to show what is owed and an example of a credit is payment in the form of valuable consideration.

A data base of genealogical data elements and their associated ratings can be created and maintained according to one or more embodiments of the invention. Such a data base can be maintained using a variety of data storage devices. Some examples of data storage devices include, but are not limited to, magnetic disk drives, optical disk drives, solid state memories, etc. In one embodiment, a storage device used to store genealogical data elements and their associated ratings can be configured with a processor and a bus as is known in the art. Such a configuration can exist within the context of a computer system. Examples of suitable computer systems include, but are not limited to, workstations, desktop computers, laptop computers, handheld computers, etc.

For purposes of discussing and understanding the embodiments of the invention, it is to be understood that various terms are used by those knowledgeable in the art to describe techniques and approaches. Furthermore, in the description, for purposes of explanation, numerous specific details are set forth in order to provide a thorough understanding of the present invention. It will be evident, however, to one of ordinary skill in the art that the present invention may be practiced without these specific details. In some instances, well-known structures and devices are shown in block diagram form, rather than in detail, in order to avoid obscuring the present invention. These embodiments are described in sufficient detail to enable those of ordinary skill in the art to practice the invention, and it is to be understood that other embodiments may be utilized and that logical, mechanical, electrical, and other changes may be made without departing from the scope of the present invention.

Some portions of the description may be presented in terms of algorithms and symbolic representations of operations on, for example, data bits within a computer memory. These algorithmic descriptions and representations are the means used by those of ordinary skill in the data processing arts to most effectively convey the substance of their work to others of ordinary skill in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, can refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

An apparatus for performing the operations herein can implement the present invention. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, hard disks, optical disks, compact disk—read only memories (CD-ROMs), and magnetic-optical disks, read-only memories (ROMs), random access memories (RAMs), electrically programmable read-only memories (EPROM)s, electrically erasable programmable read-only memories (EEPROMs), FLASH memories, magnetic or optical cards, etc., or any type of media suitable for storing electronic instructions either local to the computer or remote to the computer.

The algorithms and displays presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor, or by any combination of hardware and software. One of ordinary skill in the art will immediately appreciate that the invention can be practiced with computer system configurations other than those described, including hand-held devices, multiprocessor systems, microprocessor-based or programmable consumer electronics, digital signal processing (DSP) devices, set top boxes, network PCs, minicomputers, mainframe computers, and the like. The invention can also be practiced in distributed computing environments where tasks are performed by remote processing devices that are linked through a communications network.

The methods of the invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, driver, . . . ), as taking an action or causing a result. Such expressions are merely a shorthand way of saying that execution of the software by a computer causes the processor of the computer to perform an action or produce a result.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression. Thus, one of ordinary skill in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the present invention may be practiced as well as implemented as an embodiment).

A machine-readable medium is understood to include any mechanism for storing or transmitting information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

As used in this description, “one embodiment” or “an embodiment” or similar phrases means that the feature(s) being described are included in at least one embodiment of the invention. References to “one embodiment” in this description do not necessarily refer to the same embodiment; however, neither are such embodiments mutually exclusive. Nor does “one embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

Thus methods and apparatuses for processing genealogical data have been described.

While the invention has been described in terms of several embodiments, those of skill in the art will recognize that the invention is not limited to the embodiments described, but can be practiced with modification and alteration within the spirit and scope of the appended claims. The description is thus to be regarded as illustrative instead of limiting.

1. A method comprising:
receiving a genealogical data element; and
determining a rating wherein the rating is associated with the genealogical data element.

2. The method of claim 1, wherein the genealogical data element is selected from the group consisting of source-information, a note, a source, an event, an event detail, a birth, a date of birth, a time of birth, a place of birth, a death, a time of death, a place of death, a christening, a communion, a confirmation, a church membership, a betrothal, an engagement, a marriage, a divorce, ownership of property, a job, an office, membership in an organization, membership in a professional community, an address, a duration at a residence, a relationship, a name, a link, a link detail, an individual, a family, a photo, multimedia, a sound file, a fingerprint record, a retina scan, a dental record, a medical record, a form of identification, a rating and an adjusted rating.

3. The method of claim 1, wherein the determining performs a mathematical operation.

4. The method of claim 3, wherein the mathematical operation is selected from the group consisting of addition, subtraction, division, multiplication, a user defined operation.

5. The method of claim 3, wherein the mathematical operation is a sigmoid function.

6. The method of claim 3, wherein the mathematical operation is a transfer function.

7. The method of claim 3, wherein the mathematical operation is a user defined transfer function.

8. The method of claim 1, wherein a debit or a credit is exchanged for the determining.

9. The method of claim 1, further comprising:
receiving a rating associated with a second genealogical data element; and
using the rating associated with the second genealogical data element in the determining.

10. The method of claim 9, wherein the second genealogical data element is selected from the group consisting of source-information, a note, a source, an event, an event detail, a birth, a date of birth, a time of birth, a place of birth, a death, a time of death, a place of death, a christening, a communion, a confirmation, a church membership, a betrothal, an engagement, a marriage, a divorce, ownership of property, a job, an office, membership in an organization, membership in a professional community, an address, a duration at a residence, a relationship, a name, a link, a link detail, an individual, a family, a photo, multimedia, a sound file, a fingerprint record, a retina scan, a dental record, a medical record, a form of identification, a rating and an adjusted rating.

11. The method of claim 9, wherein the determining performs a mathematical operation.

12. The method of claim 11, wherein the mathematical operation is selected from the group consisting of addition, subtraction, division, multiplication, a user defined operation.

13. The method of claim 11, wherein the mathematical operation is a sigmoid function.

14. The method of claim 11, wherein the mathematical operation is a transfer function.

15. The method of claim 11, wherein the mathematical operation is a user defined transfer function.

16. The method of claim 9, wherein a debit or a credit is exchanged for the determining.

17. A method comprising:
associating a rating of a first genealogical data element with a rating of a second genealogical data element.

18. The method of claim 17, further comprising:
determining a rating of a third genealogical data element based on the associating.

19. The method of claim 17, wherein the first genealogical data element is selected from the group consisting of source-information, a note, a source, an event, an event detail, a birth, a date of birth, a time of birth, a place of birth, a death, a time of death, a place of death, a christening, a communion, a confirmation, a church membership, a betrothal, an engagement, a marriage, a divorce, ownership of property, a job, an office, membership in an organization, membership in a professional community, an address, a duration at a residence, a relationship, a name, a link, a link detail, an individual, a family, a photo, multimedia, a sound file, a fingerprint record, a retina scan, a dental record, a medical record, a form of identification, a rating and an adjusted rating.

20. The method of claim 17, wherein the second genealogical data element is selected from the group consisting of source-information, a note, a source, an event, an event detail, a birth, a date of birth, a time of birth, a place of birth, a death, a time of death, a place of death, a christening, a communion, a confirmation, a church membership, a betrothal, an engagement, a marriage, a divorce, ownership of property, a job, an office, membership in an organization, membership in a professional community, an address, a duration at a residence, a relationship, a name, a link, a link detail, an individual, a family, a photo, multimedia, a sound file, a fingerprint record, a retina scan, a dental record, a medical record, a form of identification, a rating and an adjusted rating.

21. The method of claim 18, wherein the determining performs a mathematical operation on the rating of the first genealogical data element and the rating of the second genealogical data element.

22. The method of claim 18, wherein the determining performs a mathematical operation.

23. The method of claim 22, wherein the mathematical operation is selected from the group consisting of addition, subtraction, division, multiplication, a user defined operation.

24. The method of claim 22, wherein the mathematical operation is a sigmoid function.

25. The method of claim 22, wherein the mathematical operation is a transfer function.

26. The method of claim 22, wherein the mathematical operation is a user defined transfer function.

27. The method of claim 18, wherein a debit or a credit is exchanged for the determining.

28. The method of claim 17, further comprising:
determining an adjusted rating of the first genealogical data element based on the associating.

29. The method of claim 28, wherein the first genealogical data element is selected from the group consisting of source-information, a note, a source, an event, an event detail, a birth, a date of birth, a time of birth, a place of birth, a death, a time of death, a place of death, a christening, a communion, a confirmation, a church membership, a betrothal, an engagement, a marriage, a divorce, ownership of property, a job, an office, membership in an organization, membership in a professional community, an address, a duration at a residence, a relationship, a name, a link, a link detail, an individual, a family, a photo, multimedia, a sound file, a fingerprint record, a retina scan, a dental record, a medical record, a form of identification, a rating and an adjusted rating.

30. The method of claim 28, wherein the second genealogical data element is selected from the group consisting of source-information, a note, a source, an event, an event detail, a birth, a date of birth, a time of birth, a place of birth, a death, a time of death, a place of death, a christening, a communion, a confirmation, a church membership, a betrothal, an engagement, a marriage, a divorce, ownership of property, a job, an office, membership in an organization, membership in a professional community, an address, a duration at a residence, a relationship, a name, a link, a link detail, an individual, a family, a photo, multimedia, a sound file, a fingerprint record, a retina scan, a dental record, a medical record, a form of identification, a rating and an adjusted rating.

31. The method of claim 28, wherein the determining performs a mathematical operation on the rating of the first genealogical data element and the rating of the second genealogical data element.

32. The method of claim 28, wherein the determining performs a mathematical operation.

33. The method of claim 32, wherein the mathematical operation is selected from the group consisting of addition, subtraction, division, multiplication, a user defined operation.

34. The method of claim 32, wherein the mathematical operation is a sigmoid function.

35. The method of claim 32, wherein the mathematical operation is a transfer function.

36. The method of claim 32, wherein the mathematical operation is a user defined transfer function.

37. The method of claim 28, wherein a debit or a credit is exchanged for the determining.

38. An apparatus comprising:
a genealogical data element; and
a rating wherein the rating is associated with the genealogical data element.

39. The method of claim 38, wherein the genealogical data element is selected from the group consisting of source-information, a note, a source, an event, an event detail, a birth, a date of birth, a time of birth, a place of birth, a death, a time of death, a place of death, a christening, a communion, a confirmation, a church membership, a betrothal, an engagement, a marriage, a divorce, ownership of property, a job, an office, membership in an organization, membership in a professional community, an address, a duration at a residence, a relationship, a name, a link, a link detail, an individual, a family, a photo, multimedia, a sound file, a fingerprint record, a retina scan, a dental record, a medical record, a form of identification, a rating and an adjusted rating.

40. The apparatus of claim 38, wherein the rating is influenced by a rating associated with a second genealogical data element.

41. The method of claim 40, wherein the second genealogical data element is selected from the group consisting of source-information, a note, a source, an event, an event detail, a birth, a date of birth, a time of birth, a place of birth, a death, a time of death, a place of death, a christening, a communion, a confirmation, a church membership, a betrothal, an engagement, a marriage, a divorce, ownership of property, a job, an office, membership in an organization, membership in a professional community, an address, a duration at a residence, a relationship, a name, a link, a link detail, an individual, a family, a photo, multimedia, a sound file, a fingerprint record, a retina scan, a dental record, a medical record, a form of identification, a rating and an adjusted rating.

42. An apparatus comprising:
a genealogical data element; and
a rating wherein the rating is associated with the genealogical data element and the rating is determined from a rating of a first genealogical data element and a rating of a second genealogical data element.

43. The apparatus of claim 42, wherein the first genealogical data element is selected from the group consisting of source-information, a note, a source, an event, an event detail, a birth, a date of birth, a time of birth, a place of birth, a death, a time of death, a place of death, a christening, a communion, a confirmation, a church membership, a betrothal, an engagement, a marriage, a divorce, ownership of property, a job, an office, membership in an organization, membership in a professional community, an address, a duration at a residence, a relationship, a name, a link, a link detail, an individual, a family, a photo, multimedia, a sound file, a fingerprint record, a retina scan, a dental record, a medical record, a form of identification, a rating and an adjusted rating.

44. The apparatus of claim 42, wherein the second genealogical data element is selected from the group consisting of source-information, a note, a source, an event, an event detail, a birth, a date of birth, a time of birth, a place of birth, a death, a time of death, a place of death, a christening, a communion, a confirmation, a church membership, a betrothal, an engagement, a marriage, a divorce, ownership of property, a job, an office, membership in an organization, membership in a professional community, an address, a duration at a residence, a relationship, a name, a link, a link detail, an individual, a family, a photo, multimedia, a sound file, a fingerprint record, a retina scan, a dental record, a medical record, a form of identification, a rating and an adjusted rating.

45. The apparatus of claim 42, wherein the rating can be determined from a mathematical operation involving the rating of the first genealogical data element and the rating of the second genealogical data element.

46. The apparatus of claim 45, wherein the mathematical operation is selected from the group consisting of addition, subtraction, division, multiplication, a user defined operation.

47. The apparatus of claim 45, wherein the mathematical operation is a sigmoid function.

48. The apparatus of claim 45, wherein the mathematical operation is a transfer function.

49. The apparatus of claim 45, wherein the mathematical operation is a user defined transfer function.

50. The apparatus of claim 42, wherein the rating associated with the genealogical data element is an adjusted rating.

51. The apparatus of claim 50, wherein the first genealogical data element is selected from the group consisting of source-information, a note, a source, an event, an event detail, a birth, a date of birth, a time of birth, a place of birth, a death, a time of death, a place of death, a christening, a communion, a confirmation, a church membership, a betrothal, an engagement, a marriage, a divorce, ownership of property, a job, an office, membership in an organization, membership in a professional community, an address, a duration at a residence, a relationship, a name, a link, a link detail, an individual, a family, a photo, multimedia, a sound file, a fingerprint record, a retina scan, a dental record, a medical record, a form of identification, a rating and an adjusted rating.

52. The apparatus of claim 50, wherein the second genealogical data element is selected from the group consisting of source-information, a note, a source, an event, an event detail, a birth, a date of birth, a time of birth, a place of birth, a death, a time of death, a place of death, a christening, a communion, a confirmation, a church membership, a betrothal, an engagement, a marriage, a divorce, ownership of property, a job, an office, membership in an organization, membership in a professional community, an address, a duration at a residence, a relationship, a name, a link, a link detail, an individual, a family, a photo, multimedia, a sound file, a fingerprint record, a retina scan, a dental record, a medical record, a form of identification, a rating and an adjusted rating.

53. The apparatus of claim 42, wherein the rating can be determined from a mathematical operation.

54. The apparatus of claim 53, wherein the mathematical operation is selected from the group consisting of addition, subtraction, division, multiplication, a user defined operation.

55. The apparatus of claim 53, wherein the mathematical operation is a sigmoid function.

56. The apparatus of claim 53, wherein the mathematical operation is a transfer function.

57. An apparatus comprising:
a storage device; and
a processor programmed to:
receive a genealogical data element;
determine a rating of the genealogical data element; and
maintain in the storage device the genealogical data element and the rating.

58. The apparatus of claim 57, wherein the genealogical data element is selected from the group consisting of source-information, a note, a source, an event, an event detail, a birth, a date of birth, a time of birth, a place of birth, a death, a time of death, a place of death, a christening, a communion, a confirmation, a church membership, a betrothal, an engagement, a marriage, a divorce, ownership of property, a job, an office, membership in an organization, membership in a professional community, an address, a duration at a residence, a relationship, a name, a link, a link detail, an individual, a family, a photo, multimedia, a sound file, a fingerprint record, a retina scan, a dental record, a medical record, a form of identification, a rating and an adjusted rating.

59. The apparatus of claim 57, wherein the processor utilizes a mathematical operation to determine the rating.

60. The apparatus of claim 59, wherein the mathematical operation is selected from the group consisting of addition, subtraction, division, multiplication, a user defined operation.

61. The apparatus of claim 59, wherein the mathematical operation is a sigmoid function.

62. The apparatus of claim 59, wherein the mathematical operation is a transfer function.

63. The apparatus of claim 59, wherein the mathematical operation is a user defined transfer function.

64. The apparatus of claim 57, wherein a debit or a credit is exchanged to maintain in the storage device the genealogical data element and the rating.

65. The apparatus of claim 57, wherein the processor is further programmed to:
receive a second genealogical data element;
determine a rating associated with the second genealogical data element; and
utilize the rating associated with the second genealogical data element to determine the rating of the genealogical data element.

66. The apparatus of claim 65, wherein the second genealogical data element is selected from the group consisting of source-information, a note, a source, an event, an event detail, a birth, a date of birth, a time of birth, a place of birth, a death, a time of death, a place of death, a christening, a communion, a confirmation, a church membership, a betrothal, an engagement, a marriage, a divorce, ownership of property, a job, an office, membership in an organization, membership in a professional community, an address, a duration at a residence, a relationship, a name, a link, a link detail, an individual, a family, a photo, multimedia, a sound file, a fingerprint record, a retina scan, a dental record, a medical record, a form of identification, a rating and an adjusted rating.

67. The apparatus of claim 65, wherein the processor utilizes a mathematical operation to determine the rating associated with the second genealogical data element.

68. The apparatus of claim 67, wherein the mathematical operation is selected from the group consisting of addition, subtraction, division, multiplication, a user defined operation.

69. The apparatus of claim 67, wherein the mathematical operation is a sigmoid function.

70. The apparatus of claim 67, wherein the mathematical operation is a transfer function.

71. The apparatus of claim 67, wherein the mathematical operation is a user defined transfer function.

72. The apparatus of claim 65, wherein a debit or a credit is exchanged to maintain in the storage device the genealogical data element and the rating.

73. An apparatus comprising:
a storage device; and
a processor programmed to:
associate a rating of a first genealogical data element with a rating of a second genealogical data element to form an association; and
maintain in the storage device the association.

74. The apparatus of claim 73, wherein the processor is further programmed to determine a rating of a third genealogical data element based on the association.

75. The apparatus of claim 73, wherein the first genealogical data element is selected from the group consisting of source-information, a note, a source, an event, an event detail, a birth, a date of birth, a time of birth, a place of birth, a death, a time of death, a place of death, a christening, a communion, a confirmation, a church membership, a betrothal, an engagement, a marriage, a divorce, ownership of property, a job, an office, membership in an organization, membership in a professional community, an address, a duration at a residence, a relationship, a name, a link, a link detail, an individual, a family, a photo, multimedia, a sound file, a fingerprint record, a retina scan, a dental record, a medical record, a form of identification, a rating and an adjusted rating.

76. The apparatus of claim 73, wherein the second genealogical data element is selected from the group consisting of source-information, a note, a source, an event, an event detail, a birth, a date of birth, a time of birth, a place of birth, a death, a time of death, a place of death, a christening, a communion, a confirmation, a church membership, a betrothal, an engagement, a marriage, a divorce, ownership of property, a job, an office, membership in an organization, membership in a professional community, an address, a duration at a residence, a relationship, a name, a link, a link detail, an individual, a family, a photo, multimedia, a sound file, a fingerprint record, a retina scan, a dental record, a medical record, a form of identification, a rating and an adjusted rating.

77. A computer readable medium containing executable computer program instructions, which when executed by a data processing system, cause the data processing system to perform a method comprising:
receiving a genealogical data element; and
determining a rating wherein the rating is associated with the genealogical data element.

78. The computer readable medium of claim 77, wherein the genealogical data element is selected from the group consisting of source-information, a note, a source, an event, an event detail, a birth, a date of birth, a time of birth, a place of birth, a death, a time of death, a place of death, a christening, a communion, a confirmation, a church membership, a betrothal, an engagement, a marriage, a divorce, ownership of property, a job, an office, membership in an organization, membership in a professional community, an address, a duration at a residence, a relationship, a name, a link, a link detail, an individual, a family, a photo, multimedia, a sound file, a fingerprint record, a retina scan, a dental record, a medical record, a form of identification, a rating and an adjusted rating.

79. The computer readable medium of claim 77, wherein the determining performs a mathematical operation.

80. The computer readable medium, as set forth in claim 77, the method further comprising:
receiving a rating associated with a second genealogical data element; and
using the rating associated with the second genealogical data element in the determining.

81. The computer readable medium of claim 80, wherein the second genealogical data element is selected from the group consisting of source-information, a note, a source, an event, an event detail, a birth, a date of birth, a time of birth, a place of birth, a death, a time of death, a place of death, a christening, a communion, a confirmation, a church membership, a betrothal, an engagement, a marriage, a divorce, ownership of property, a job, an office, membership in an organization, membership in a professional community, an address, a duration at a residence, a relationship, a name, a link, a link detail, an individual, a family, a photo, multimedia, a sound file, a fingerprint record, a retina scan, a dental record, a medical record, a form of identification, a rating and an adjusted rating.

82. The computer readable medium of claim 80, wherein the determining performs a mathematical operation.

83. The computer readable medium of claim 82, wherein the mathematical operation is selected from the group consisting of addition, subtraction, division, multiplication, a user defined operation.

84. The computer readable medium of claim 82, wherein the mathematical operation is a sigmoid function.

85. A computer readable medium containing executable computer program instructions, which when executed by a data processing system, cause the data processing system to perform a method comprising:
associating a rating of a first genealogical data element with a rating of a second genealogical data element.

86. The computer readable medium, as set forth in claim 85, the method further comprising:
determining a rating of a third genealogical data element based on the associating.

87. The computer readable medium of claim 85, wherein the first genealogical data element is selected from the group consisting of source-information, a note, a source, an event, an event detail, a birth, a date of birth, a time of birth, a place of birth, a death, a time of death, a place of death, a christening, a communion, a confirmation, a church membership, a betrothal, an engagement, a marriage, a divorce, ownership of property, a job, an office, membership in an organization, membership in a professional community, an address, a duration at a residence, a relationship, a name, a link, a link detail, an individual, a family, a photo, multimedia, a sound file, a fingerprint record, a retina scan, a dental record, a medical record, a form of identification, a rating and an adjusted rating.

88. The computer readable medium of claim 85, wherein the second genealogical data element is selected from the group consisting of source-information, a note, a source, an event, an event detail, a birth, a date of birth, a time of birth, a place of birth, a death, a time of death, a place of death, a christening, a communion, a confirmation, a church membership, a betrothal, an engagement, a marriage, a divorce, ownership of property, a job, an office, membership in an organization, membership in a professional community, an address, a duration at a residence, a relationship, a name, a link, a link detail, an individual, a family, a photo, multimedia, a sound file, a fingerprint record, a retina scan, a dental record, a medical record, a form of identification, a rating and an adjusted rating.

89. The computer readable medium of claim 86, wherein the determining performs a mathematical operation on the rating of the first genealogical data element and the rating of the second genealogical data element.

90. The computer readable medium of claim 86, wherein the determining performs a mathematical operation.

91. The computer readable medium of claim 90, wherein the mathematical operation is selected from the group consisting of addition, subtraction, division, multiplication, a user defined operation.

92. The computer readable medium of claim 90, wherein the mathematical operation is a sigmoid function.

93. The computer readable medium of claim 90, wherein the mathematical operation is a transfer function.

94. The computer readable medium of claim 90, wherein the mathematical operation is a user defined transfer function.

95. The computer readable medium of claim 86, wherein a debit or a credit is exchanged for the determining.

96. The computer readable medium, as set forth in claim 85, the method further comprising:
determining an adjusted rating of the first genealogical data element based on the associating.

97. The computer readable medium of claim 96, wherein the first genealogical data element is selected from the group consisting of source-information, a note, a source, an event, an event detail, a birth, a date of birth, a time of birth, a place of birth, a death, a time of death, a place of death, a christening, a communion, a confirmation, a church membership, a betrothal, an engagement, a marriage, a divorce, ownership of property, a job, an office, membership in an organization, membership in a professional community, an address, a duration at a residence, a relationship, a name, a link, a link detail, an individual, a family, a photo, multimedia, a sound file, a fingerprint record, a retina scan, a dental record, a medical record, a form of identification, a rating and an adjusted rating.

98. The computer readable medium of claim 96, wherein the second genealogical data element is selected from the group consisting of source-information, a note, a source, an event, an event detail, a birth, a date of birth, a time of birth, a place of birth, a death, a time of death, a place of death, a christening, a communion, a confirmation, a church membership, a betrothal, an engagement, a marriage, a divorce, ownership of property, a job, an office, membership in an organization, membership in a professional community, an address, a duration at a residence, a relationship, a name, a link, a link detail, an individual, a family, a photo, multimedia, a sound file, a fingerprint record, a retina scan, a dental record, a medical record, a form of identification, a rating and an adjusted rating.

99. The computer readable medium of claim 96, wherein the determining performs a mathematical operation on the rating of the first genealogical data element and the rating of the second genealogical data element.

100. The computer readable medium of claim 96, wherein the determining performs a mathematical operation.

101. The computer readable medium of claim 100, wherein the mathematical operation is selected from the group consisting of addition, subtraction, division, multiplication, a user defined operation.

102. The computer readable medium of claim 100, wherein the mathematical operation is a sigmoid function.

103. The computer readable medium of claim 100, wherein the mathematical operation is a transfer function.

104. The computer readable medium of claim 100, wherein the mathematical operation is a user defined transfer function.

105. The computer readable medium of claim 96, wherein a debit or a credit is exchanged for the determining.

106. An apparatus comprising:
means for representing genealogical data;
means for determining a rating of genealogical data; and
means for associating the genealogical data and the rating.

107. The apparatus of claim 106, further comprising:
means for adjusting the rating of the genealogical data.

108. The apparatus of claim 106, further comprising:
means for storing the genealogical data and the rating.

109. An apparatus comprising:
genealogical data element means;
means for rating, wherein a rating of the genealogical data element means can be obtained; and
association means for associating the genealogical data element means with the rating.

110. The apparatus of claim 109, further comprising:
adjusting means, wherein the rating can be adjusted.

111. The apparatus of claim 109, further comprising:
means for storing the genealogical data element means and the rating.
